(19) United States
(12) Patent Application Publication
(10) Pub. No.: US 2024/0401550 A1
(43) Pub. Date: Dec. 5, 2024

(54) DUAL PRE-CLEANER AIR FILTER DESIGN

(71) Applicant: Caterpillar Inc., Peoria, IL (US)

(72) Inventors: Philip C. Spengler, Washington, IL (US); Corey C. Eadie, Metamora, IL (US)

(73) Assignee: Caterpillar Inc., Peoria, IL (US)

(21) Appl. No.: 18/203,440

(22) Filed: May 30, 2023

(51) Int. Cl. F02M 35/022; F02M 35/02

(52) U.S. Cl. CPC F02M 35/0223; F02M 35/0216

(57) ABSTRACT

An air cleaner may include a container body having a first end and a second end and defining an air flow chamber and a dust flow chamber each defining separate internal cavities within the container body. The air cleaner may also include an intake arranged at the first end of the container body and comprising a wall system for receiving air from outside the container body through an inlet in the side of the container body. The intake may include a dust flow path in fluid communication with and in general alignment with the inlet and extending from the inlet to a dust opening leading to the dust flow chamber. The intake may also include an airflow path abruptly and angularly diverging from the dust flow path at a point downstream of the inlet and extending from the dust flow path to an air opening leading to the air flow chamber.

### TECHNICAL FIELD

The present application relates to air cleaners for cleaning air entering a combustion engine such as engines on work machines, generators, or other equipment. More particularly, the present application relates to mechanisms for controlling air and dirt flow paths of the air cleaner that diverges air and dirt through different flow paths to clean the air. Still more particularly, the present application relates to a design that creates diversion of dirt and air at multiple stages of the air cleaner.

### BACKGROUND

Engines on work machines receive air through an air intake. Engines can include a filter and/or air cleaner prior to the air intake to remove dirt and dust. The filter can include a fibrous or porous material to remove solid particles from the air. The solid particles can include dust, pollen, mold, and bacteria. The work machine can optionally include an air cleaner positioned prior to the filter to provide additional dirt and dust removal before air enters the filter. This can be useful to prolong the operational life of the filter, for example, by removing larger particles and preventing the same from quickly clogging the filter.

### SUMMARY

In one or more examples, an air cleaner may include a container body having a first end and a second end and defining an air flow chamber and a dust flow chamber each defining separate internal cavities within the container body. The air cleaner may also include an intake arranged at the first end of the container body and comprising a wall system for receiving air from outside the container body through an inlet in the side of the container body. The intake may include a dust flow path in fluid communication with and in general alignment with the inlet and extending from the inlet to a dust opening leading to the dust flow chamber. The intake may also include an airflow path abruptly and angularly diverging from the dust flow path at a point downstream of the inlet and extending from the dust flow path to an air opening leading to the air flow chamber.

In one or more examples, a work machine may include a frame and an engine mounted on the frame, configured to perform work, and including a combustion air intake. The work machine may also include an air cleaner including a container body having a first end and a second end and defining an air flow chamber and a dust flow chamber each defining separate internal cavities within the container body. The air cleaner may also include an intake arranged at the first end of the container body and comprising a wall system for receiving air from outside the container body through an inlet in the side of the container body. The intake may include a dust flow path in fluid communication with and in general alignment with the inlet and extending from the inlet to a dust opening leading to the dust flow chamber. The intake may also include an airflow path abruptly and angularly diverging from the dust flow path at a point downstream of the inlet and extending from the dust flow path to an air opening leading to the air flow chamber.

In one or more examples, a method of dust removal may include directing air from outside a container body having a first end and a second end, through an inlet into an intake arranged at a first end of the container body. The method may also include directing the air from the outside through a wall system of the intake and diverging a dust flow path and an airflow path of the air from the outside. The dust flow path may be in fluid communication with and in general alignment with the inlet and extending from the inlet to a dust opening leading to a dust flow chamber defined by the container body. The airflow path may be at a point downstream of the inlet and may extend from the dust flow path to an air opening leading to an air flow chamber defined by the container body.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an engine in conjunction with an air filtration system, according to one or more examples.

FIG. 2 is a top perspective view of one example of an intake of the air filtration system of FIG. 1, according to one or more examples.

FIG. 3 is a lateral cross-sectional view of the air filtration system of FIG. 1, according to one or more examples.

FIG. 4 is a top perspective side view of another example of an intake for the air filtration system of FIG. 1, according to one or more examples.

### DETAILED DESCRIPTION

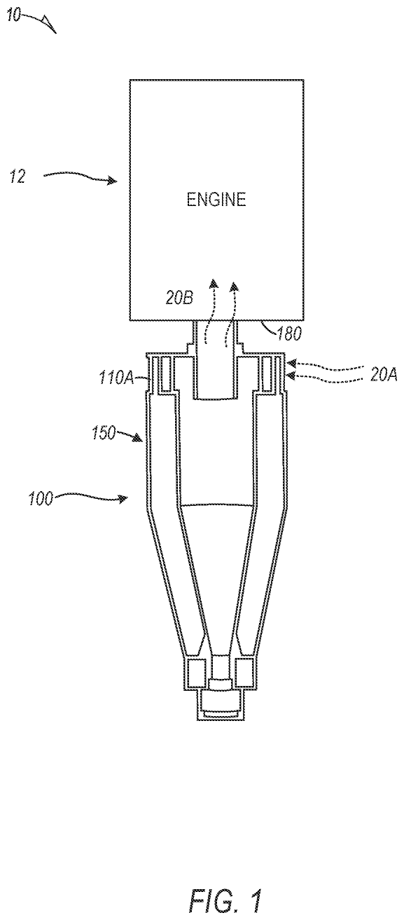

FIG. 1 is a perspective view of an air filtration system 100 suitable for use with a work machine 10 or other air intake on a combustion engine, for example. The air filtration system 100 may be configured to treat air from around the work machine to make it suitable for use in combustion processes within the engine. While not shown, work machines may include equipment such as loaders, excavators, haul trucks, crawlers, rotary mixers, pavers, milling machines, stationary engines, and other types of machines adapted to perform work. These machines may include a frame with a combustion engine arranged thereon to provide power to the work machine, which may be used to operate a motive system such as a tracked or wheeled system. The combustion engine 12 may also provide rotational power to a hydraulic system for operating an implement of the work machine. The work machine may include an electronic control module for receiving inputs from an onboard or remote operator to operate the motive system and/or the hydraulic system. As shown, the air filtration system 100 may be arranged adjacent to and fluidly coupled to a combustion engine on the work machine and may function to clean the air entering the combustion engine. While the present air filtration system and air cleaner thereof are described in conjunction with a work machine, the system may be suitable for use with any combustion engine arranged on any type of equipment.

With continued reference to FIG. 1, as mentioned, the work machine 10 may include the air filtration system 100 configured to treat air. The air filtration system 100 receives or draws in outside ambient air 20A from around a work machine to remove dust, debris, dirt, and other particles from the air to provide clean air to the engine 12. The air filtration system 100 includes an intake 110A and a container body 150. The intake 110A receives the outside ambient air 20A, provides a first stage of dust removal to the air, and is in fluid communication with the container body 150. The container body 150 receives air from the intake 110A, provides a second stage and/or third stage of dust removal to the air, and is in fluid communication with the engine 12 via the cleaned air outlet 182, to provide cleaned air 20B. In one or more examples, the cleaned air outlet 182 may be in fluid communication with the engine via an air filter (not shown).

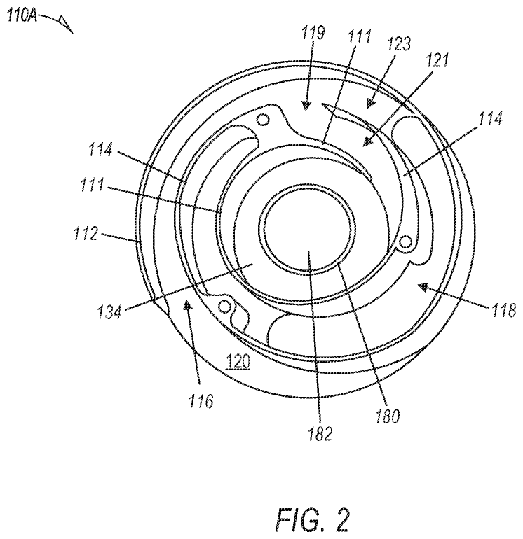

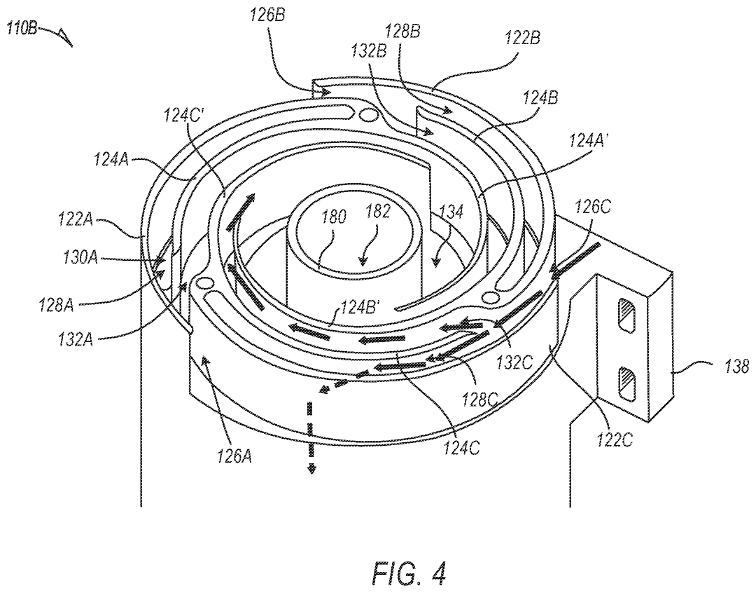

Referring now to FIG. 2, one example of an intake 110A is shown. Another example of an intake 110B is shown in FIG. 4. The intake 110A includes a single inlet, while the intake 110B includes multiple inlets. For simplicity purposes, the single inlet intake 110A will be described first. The intake 110A may be configured to provide a first stage of cleaning prior to directing the air into the container body 150 for further cleaning. For example, the intake 110A may use a particular air flow technique to facilitate separation of dust, debris, dirt, and other particles from air flow and separately divert the air flow and dust, debris, dirt, and other particles to the container body. The intake 110A may be generally cylindrical and adapted to sit atop the container body 150. The intake 110A may include a generally spirally arranged wall system 112 defining an inlet 116, an initial air/dirt flow path 113, a flow path branch 119 and an air flow path 121 as well as a dirt flow path 123 each downstream of the branch 119. The intake 110A may also include an air opening 134 arranged at a downstream end of the air flow path 121 and a dust opening 118 arranged at a downstream end of the dust flow path 123. Each of these openings may lead to respective chambers within the container body 150. As shown, a cleaned air outlet 182 may also pass through a central portion of the intake 110A. As discussed in more detail below, the cleaned air outlet 182 may carry cleaned air from the container body 150 to the engine or additional portion of the filtration system 100. While the cleaned air outlet 182 is shown passing through the center of the intake 110A, other routing of the cleaned air outlet 182A may be provided such as out a side of the container body 150, for example. While not shown in FIG. 2, the intake 110A may also include a cover to enclose the intake 110A. The intake 110A may also include a bottom 120, separating the intake 110A from the container body 150.

As shown, the generally spirally arranged wall system 112 partially surrounds a circumference of the intake 110A, defining an exterior wall of the intake 110A, before curving inward in a generally spiral arrangement around a central axis of the first intake 110A. The generally spirally arranged wall system 112, upon curving inward, defines an inner wall 114 of the generally spirally arranged wall system 112. Thus, the generally spirally arranged wall system 112 and the inner wall 114 may define the inlet 116 at a location where the generally spirally arranged wall system 112 begins. The generally spirally arranged wall system 112 may continue to generally spiral within the intake 110A around the central axis of the intake 110A and may define a substantially uniform and curved initial air/dirt flow path 113. At a point downstream of the inlet 116 along the air/dirt flow path 113, a flow path branch 119 may be provided by an inward turning of the inner wall 114. That is, as the generally spirally arranged wall system 112 continues to spiral and form the inner wall 114, the inner wall may abruptly divert radially inward. After (i.e., downstream) diverting inward, the inner wall may give way to an inner most wall 111 that curves back along and offset from the inner wall 114 towards the direction of the inlet 116 while another portion of the inner most wall 111 continues to spiral along, but is offset from, the inner wall 114. That is, at the location of the flow path branch 119 and downstream of the branch 119 from the initial air/dirt flow path 113, an additional portion of the inner wall 114 may restart and be in general curved alignment with the portion of the inner wall 114 upstream of the branch 119. This additional portion of the inner wall 114 together with the outer circumferential portion of the wall system 112 may define a dirt flow path 123 that is in general curved alignment with the initial air/dirt flow path 113. In addition, this additional portion of the inner wall 114 together with the inner most wall 111 may define an air flow path 121 that is in a similar curved direction as the initial air/dirt flow path 113, but is offset from the course of the initial air/dirt flow path 113. Accordingly, the initial air/dirt flow path 113 may diverge into two separate flow paths (e.g., air flow path 121/dirt flow path 123). As shown, the air flow path 121 and the dirt flow path 123 may continue alongside one another around the central axis of the intake 110A separated by the portion of the inner wall 114 downstream of the branch 119. The dirt flow path 123 may lead to a dust opening 118 in the bottom 120 of the intake and the air flow path 121 may lead to an air opening 134 in the bottom 120 of the intake 110A. As shown, the inner most wall 111 may terminate at a selected distance downstream of the branch to allow air in the air flow branch to reach the air flow opening and maintain its spiraling motion as it passes into the container body 150. In addition, and as shown, the portion of the inner wall 114 downstream of the branch 119 may continue in spiral fashion and between the dirt flow path 123 and the air flow path 121 until it meets up with and continues as the inner most wall 111. While intake 110A is shown and described with a generally spirally arranged wall system 112, intake 110A may include a generally longitudinally arranged wall system that incorporates similar features of the generally spirally arranged wall system 112. For example, the generally longitudinally arranged wall system may similarly include, at a point downstream of an inlet along an air/dirt flow path, a flow path branch that may be provided by a turning of generally longitudinally arranged wall system. The flow path branch would similarly cause an abrupt diversion of air flow where the momentum of the dirt/dust causes it to stay its course and the air moves abruptly laterally into a separate flow path.

The inlet 116 may be defined by the generally spirally arranged wall system 112, as well as the cover and bottom 120. While a single inlet has been shown, multiple inlets may be provided as shown, for example, in FIG. 4. The inlet 116 receives air from the outside and aids in directing air to the flow path defined by the generally spirally arranged wall system 112. In an example, the generally spirally arranged wall system 112 defining the inlet 116 may include a rounded edge at the inlet 116 to aid in directing the air into the first intake 110A. In another example, the generally spirally arranged wall system 112 defining the inlet 116 may include a varied wall thickness at the inlet to modify the air flow of air into the first intake 110A. For example, a narrower wall thickness may widen the inlet 116, increasing the air flow into the first intake 110A. As another example, a thicker wall thickness may narrow the inlet 116, decreasing the air flow into the first intake 110A.

As discussed, the dirt flow path 123 may lead to a dust opening 118. The dust opening 118 may include an aperture in the bottom 120. The dust opening 118 may extend along the bottom 120 within the generally spirally arranged wall system 112 and, in particular, within the boundaries of the dirt flow path 123. That is, as the dust flow path continues around the peripheral portion of the intake 110, the floor of the dust flow path 123 may be omitted allowing the dirt/dust/debris to fall into a dust flow chamber 162 of the container body. The dust flow path 123 may continue for a short distance beyond the dust opening until it reaches the location of the inwardly turned inner wall 114 at the branch 119.

As also discussed, the air flow path 121 may lead to an air opening 134 Like the dust opening 118, the air opening 134 may include an aperture in the bottom 120 of the intake 110A. The air opening 134, may be generally central to the intake and may include a generally circular opening in the bottom 120 of the intake. As mentioned, the inner most wall 111 may stop at some point along the air flow path 121 allowing the air to flow into the central area of the intake and continue its spiral motion as it drops down through the air opening 134 and into the air flow chamber 168 of the container body 150. As shown, a cleaned air outlet 182 may be provided at a center of the intake and may extend up from the air flow chamber 168 of the container body, through the air opening 134, and out a top of the intake 110A. In this case, the outer wall of the cleaned air outlet 182 may create an annular space for the air flow coming from the air flow path 121 to pass through the bottom 120 of the intake 110A and into the air flow chamber 168 of the container body 150.

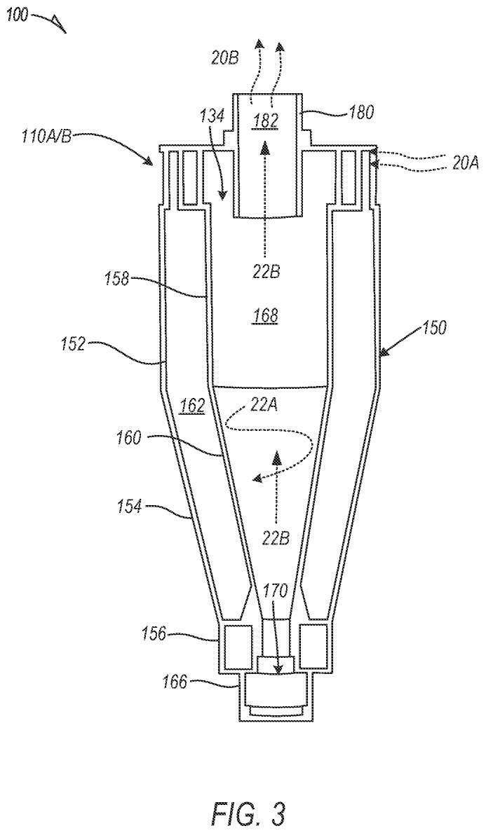

Referring now to FIG. 3, the intake 110A (alternatively intake 110B) is shown coupled to the container body 150. The container body includes a first end and a second end, and the intake 110A is positioned at the first end of the container body 150. As described above, air from the outside 20A, such as ambient air, enters the intake 110A. After the air has passed through the intake 110A for a first cleaning, air and dust separately enter the container body 150 through the respective air opening 134 and dust opening 118.

The container body 150 is configured to collect and contain dust received via the dust flow opening and to further process air received from the air opening 134. In particular, the container body 150 may be configured to remove finer dust from the air that was not removed from the air by the intake 110A. For purposes of containing the dust from the dust flow opening 118, the container body 150 may include a dust flow chamber 162 and to remove finer dust from the air, the container body may include an airflow chamber 168. Each of the dust flow chamber 162 and the airflow chamber 168 may define separate internal cavities within the container body 150. More specifically, the dust flow chamber 162 may be defined on an outer periphery by an exterior cylindrical chamber portion 152 and an exterior conical chamber portion 154. The dust flow chamber may be defined on a radially inner side by the structures defining the air flow chamber 168. A dust collection chamber 156 may also be provided at a bottom end of the dust flow chamber 162. The airflow chamber 168 may be defined on an outer periphery thereof by an interior cylindrical chamber portion 158 and an interior conical chamber portion 160. A second dust collection chamber 166 may be provided for dust captured by the airflow chamber 168. Accordingly, the air flow chamber 168 extends through the dust flow chamber 162 along the central longitudinal axis of the dust flow chamber 162 or container body 150. For example, the air flow chamber 168 may be concentrically arranged within the dust flow chamber.

The exterior cylindrical chamber portion 152 may be positioned at the first end of the container body 150. The exterior cylindrical chamber portion 152 may have diameter substantially similar to a diameter of the intake 110A. The exterior cylindrical portion 152 may be substantially ring or cylindrically shaped. The dust flow chamber 162, and more specifically, the portion of the dust flow chamber 162 defined by the exterior cylindrical chamber portion 152 may be in fluid communication with the dust opening 118. Accordingly, dust, dirt, debris, and other particles from the dust flow path 123 that flow through the dust opening 118 may fall into the portion of the dust flow chamber defined by the exterior cylindrical portion 152.

The exterior conical chamber portion 154 may be coupled to the cylindrical chamber portion proximal to the second end of the container body 150. The exterior conical chamber portion 154 narrows as the exterior chamber portion 154 extends towards the second end of the container body 150. The exterior conical chamber portion 154 may aid in directing dust towards the first dust collection chamber 156. In another example, the exterior chamber portion 154 may be cylindrical and substantially similar in size and shape to the exterior cylindrical chamber portion 152.

The first dust collection chamber 156 may positioned at the second end of the container body 150. The first dust collection chamber 156 may be substantially cylindrical. The first dust collection chamber 156 may be ring shaped. A portion of the first dust collection chamber 156 may be removably coupled to remove dust, dirt, debris, and other particles from the dust flow chamber 162. For example, the portion of the first dust collection chamber 156 may be removably coupled to another portion of the first dust collection chamber 156. As another example, the portion of the first dust collection chamber 156 may be removably coupled to the exterior conical chamber portion 154. The portion of the first dust collection chamber 156 may be removably coupled via a threaded coupling, snap fit, or another coupling mechanism.

The interior cylindrical chamber portion 158 may be positioned at the first end of the container body 150. The interior cylindrical chamber portion 158 may define an interior wall of the dust flow chamber 162. The airflow chamber 168, and more specifically, the portion of the chamber 168 defined by the interior cylindrical chamber portion 158, may be fluidly coupled to the air flow path 121 via the air opening 134 at a first end of the interior cylindrical chamber portion 158. Accordingly, the interior cylindrical chamber portion 158 may have a diameter to surround the air opening 134. In an example, the air opening 134 is positioned at the first end of the air flow chamber 168 and the interior cylindrical chamber portion 158 may align with an outer perimeter of the air opening 134. As air flows into the airflow chamber 168, and more specifically, the portion defined by the interior cylindrical chamber portion 158, the air may flow in a generally spiral airflow configuration 22A as it flows from the first end to the second end. That is, the spiraling motion of the air generated by the intake 110A may continue as the air flows through the air opening 134 and into the air flow chamber 168. The generally spiral airflow configuration 22A may facilitate additional separation of dust, dirt, debris, and other particles from the air due to the inability of the air to change the direction of the dust during its whirling motion.

The interior conical chamber portion 160 is positioned at the second end of the container body 150. The interior conical chamber portion 160 defines an interior wall of the portion of the dust flow chamber 162 defined by the exterior conical chamber 154. The portion of the air flow chamber 168 defined by the interior conical chamber portion 160 may be fluidly coupled to the portion of the air flow chamber defined by the interior cylindrical chamber portion 158. The interior conical chamber portion 160 may narrow as the interior conical chamber portion 160 extends from the interior cylindrical chamber portion 158 to the second end of the container body 150. The interior conical chamber portion 160 may aid in additional separation of dust, dirt, debris, and other particles from the air. The interior conical chamber portion 160 may also aid in directing the dust, dirt, debris, and other particles toward a second dust collection chamber 166 via a dust path 170. Still further, the interior conical chamber portion 160 may aid in redirecting the cleaned air from the generally spiral airflow configuration 22A flowing from the first end to the second end, to a cleaned air flow 22B that flows from the second end to the first end. The cleaned air flow 22B may be directed through the cleaned air outlet 182 and out of the air filtration system. For example, the cleaned air flow 22B can be directed to an engine.

The second dust collection chamber 166 may be positioned at the second end of the container body 150 and may be in fluid communication with the internal conical chamber portion 160. The second dust collection chamber 166 may be substantially cylindrical. The second dust collection chamber 166 may be substantially internal to the first dust collection chamber 156. In another example, the second dust collection chamber 166 is positioned distal to the first dust collection chamber 156.

A portion of the second dust collection chamber 166 may be removably coupled to remove dust, dirt, debris, and other particles from the airflow chamber 168. For example, the portion of the second dust collection chamber 166 may be removably coupled to another portion of the second dust collection chamber 166. As another example, the portion of the second dust collection chamber 166 may be removably coupled to the interior conical chamber portion 160. The portion of the second dust collection chamber 166 may be removably coupled via a threaded coupling, snap fit, or another coupling mechanism.

As may be appreciated from a review of the above disclosure, the air filtration system may be effective to separate dust, dirt, debris, and other materials may be removed from the air based on at least two, if not three, techniques within the system. That is, a first technique may include an abrupt offsetting of the air flow path where the abrupt change in direction of the air creates an inability for the air to redirect heavier dust particles that, instead, continue generally along the path. A second technique may include use of cyclonic motion within the container body 150 to further separate dust. Yet a third technique may include a direction reversal where the air flowing down into the container body is then redirected upward and out of the clean air outlet 182. In one or more examples, the cyclonic motion and the direction reversal may occur simultaneously or within a single chamber within the container body (e.g., the air flow chamber 168). As may be appreciated, these efforts to remove dust, dirt, and/or debris may create clean air that is suitable for entry into the combustion operations of a combustion engine or are at least more suitable for passing through an air filter with a filter media such that the pre-cleaning efforts prolong the life of the filter media. As mentioned above, while an intake 110A with a single inlet is shown and described with respect to FIG. 2, multiple intakes may be provided.

Referring now to FIG. 4, another example of an intake 110B is shown. The intake 110B may be configured to clean incoming air prior to directing the air into the container body for further cleaning. Like the intake 110A, the intake 110B may use a particular air flow technique to facilitate separation of dust, debris, dirt, and other particles from air flow and separately divert the air flow and dust, debris, dirt, and other particles to the container body. The intake 110B may be cylindrical and include a generally spirally arranged wall system 122, a plurality of inlets 126, and a cleaned air outlet 182. While not shown in FIG. 3, the intake 110B may include a cover to enclose the intake 110B. The intake 110B may also include a bottom, separating the intake 110B from the container body 150.

The generally spirally arranged wall system may be similar to the spirally arranged wall system 112 except that three inlets may be provided As shown, the intake 110B may include structures that are similar to those of intake 110A and each inlet may lead to a series of structures that make up approximately ⅓ of the circumference of the intake and may overlap with one another slightly. Each intake may lead to a branch portion dividing the flow into a dust flow and an air flow, where the dust flow leads to a dust opening at or near the perimeter of the intake and the air flow leads to an air opening at or near a central area of the intake. While intake 110B is shown and described with a generally spirally arranged wall system 112, intake 110B may include a generally longitudinally arranged wall system that incorporates similar features of the generally spirally arranged wall system 112. For example, the generally longitudinally arranged wall system may similarly include, at multiple points downstream of the three inlets along an air/dirt flow path, a branch portion that may be provided by a turning of generally longitudinally arranged wall system. The flow path branch would similarly cause an abrupt diversion of air flow where the momentum of the dirt/dust causes it to stay its course and the air moves abruptly laterally into a separate flow path.

More particularly, the intake 110B may include a plurality of generally spirally arranged wall segments. Each of the segments 122A, 122B, and 122C may partially surround a circumference of the second intake 110B, such that the segments 122A, 122B, and 122C of the generally spirally arranged wall system define an exterior wall of the second intake 110B. That is, the segments 122A, 122B, and 122C, may take the place of the portion of the wall system 112 that forms the perimeter of the intake 110A. Each of the segments 122A, 122B, and 122C of the generally spirally arranged wall system may be a substantially similar size and/or shape. In an example, each of the segments 122A, 122B, and 122C of the generally spirally arranged wall system 122, after partially surrounding a circumference of the second intake 110B, gradually begins curving or spiraling inward. In another example, each of the segments 122A, 122B, and 122C begin on a circumference of the second intake 110B and gradually spiral inward without following the circumference of the second intake 110B. As each of the segments 122A, 122B, and 122C spiral inward to a location proximal another of the segments 122A, 122B, and 122C, an inlet may be created, collectively defining the plurality of inlets 126A, 126B, and 126C. For example, the segments 122B and 122A may create inlet 126B.

Like the intake 110A, and downstream of the inlets 126A, 126B, and 126C, the initial air/dirt flow path may branch into a dirt flow path and an air flow path. Like intake 110A, the branch may be created by an abrupt inward turning of the portion of the segment 122A, 122B, and 122C that is arranged radially inward of the initial air/dirt flow path. After abruptly turning inward, the segment may give way to an interior segment 124A, 124B, or 124C (e.g., akin to inner most wall 111 of intake 110A). One of these interior segments will be described noting that each interior segment may be generally the same as the others. For example, a first portion of the interior segment 124A may continue to spiral toward a central longitudinal axis of the intake 110B defining a radially inner boundary of the air flow path while a second portion of the interior segment 124A may turn back the other direction and run generally along, but offset from, its respective segment 122A. For example, this second portion of interior segment 124A may turn back towards the beginning of segment 122A. In an example, the second portion of interior segment 124A and the segment 122A may be substantially parallel and may define a dust flow path 128. The first portion of the interior segment 124A that continues and spirals inward may spiral inward closer to the central axis than the second portion of the interior segment 124A such that the first portion of the interior segment 124A may be spaced radially inward from the second portion of interior segment 124B. The second portion of interior segment 124B and the first portion of interior segment 124A may define an airflow path downstream of the branch.

The first and second portions of interior segment 124A may substantially mirror each other or otherwise, and collectively, define a substantially circular portion, a substantially oval shaped portion, or an oblong shape. However, the first portion of the interior segment 124A and the second portion of the interior segment 124A as a collective may be offset from the central longitudinal axis of the intake 110B. While the interior segments 124A have been described, the segments 124B and 124C may have similar first and second portions. As noted, the arrangement of the segment 122A, the second portion of interior segment 124A, and the first portion of interior segment 124C define two separate flow paths: the dust flow path (e.g., between 122A and second portion of 124A) and the airflow path (e.g., between second portion of 124A and first portion of 124C). The divergence of the any given segment 122A, 122B, or 122C after it passes by the inlet creates an abrupt change in direction of the air which may cause dust, dirt, and debris to separate from the air and continue along its path rather than follow the abrupt change in direction.

The inlets may be defined by the generally spirally arranged wall system, as well as the cover and bottom of the intake 110B. Each of the plurality of inlets 126A, 126B, and 126C may receive air from the outside and aid in directing air to a flow path defined by the generally spirally arranged wall system. In an example, the generally spirally arranged wall system defining the inlet may include a rounded edge at the inlet to aid in directing the air into the intake 110B. In another example, the generally spirally arranged wall system defining the inlet may include a varied wall thickness at the inlet to modify the air flow of air into the second intake 110B. For example, a narrower wall thickness may widen the inlet, increasing the air flow into the intake. As another example, a thicker wall thickness may narrow the inlet, decreasing the air flow into the intake 110B. In an example, each of the inlets 126A, 126B, 126C may be substantially similar. In another example, one of the inlets 126A, 126B, or 126C may be designated as a primary, secondary, and/or tertiary inlet and have a modified inlet to change the flow of air into the inlet based on the designation.

The intake 110B may include a plurality of dust flow paths 128A, 128B, and 128C. For example, dust flow path 128A is defined by the segment 122A and the second (e.g., turned back) portion of interior segment 124A. Dust flow paths 128B and 128C may be similarly defined by the segments and second portion of the respective interior segment. The dust flow path 128A is in fluid communication with the inlet 126A. The dust flow path 128A may be in general alignment with the inlet as the inlet 126A and the dust flow path 128A share the segment 122A. Each of the dust flow paths 128A, 128B, and 128C may be arranged to direct dust, dirt, debris, and other particles along the dust flow path 128A, 128B, and 128C. Each of the dust flow paths 128A, 128B, and 128C may extend from their respective inlet 126A, 126B, and 126C to a dust opening 130A, 130B, and 130C.

The dust openings 130A, 130B, and 130C may be an aperture in the bottom of the intake 110B. The dust openings 130A, 130B, and 130C may be a ramp into the dust flow chamber 162 of the container body. Each of the dust openings 130A, 130B, and 130C may be positioned in their respective dust flow paths 128A, 128B, and 128C. Accordingly, the dust openings 130A, 130B, and 130C may be shaped to follow a portion of the generally spirally arranged wall system. Each of the dust openings 130A, 130B, and 130C may lead to a dust flow chamber 162 of the container body 150. For example, all of the dust openings 130A, 130B, and 130C may lead to the same dust flow chamber 162 of the container body 150. The dust opening 130A may be positioned along the second portion of the interior segment 124A.

The intake 110B may also include a plurality of airflow paths 132A, 132B, and 132C. For example, airflow path 132A is defined by the second portion of interior segment 124A and the first portion of interior segment 124C. Airflow paths 132B and 132C may be similarly defined by the second portion of their respective interior segment and the first portion of their neighboring interior segment. The airflow path 132A may be in fluid communication with the inlet 126A and is downstream from the inlet 126A. The airflow path 132A may abruptly and angularly diverge at a branch where the dust flow path 128A continues generally aligned with the incoming air from the inlet 126A while the air flow path abruptly moves to the side out of alignment with the inlet 126A and then continues spirally around the intake. In an example, a shape of the end of the second portion of the interior segment 124A may be configured to aid in abruptly and angularly diverging the dust flow paths and airflow paths. For example, the end of the second portion of the interior segment 124A may be rounded or flared to cause air to flow toward the airflow path 132A. This disruption may aid in directing air along the air flow path while dust, dirt, debris, and other particles continue passed the flaring along the dust flow path. The airflow paths may extend from the divergence from the dust flow path to an air opening 134.

The air opening 134 may be an aperture in the bottom of the intake 110B downstream from the divergence of the airflow paths and dust flow paths. The air opening 134 may include a generally spirally arranged ramp into the airflow chamber 168 of the container body 150. The air opening 134 may be positioned interior the generally spirally arranged wall system and surrounding a cleaned air outlet 182. Accordingly, the air opening 134 may be substantially ring or annularly shaped. Each of the airflow paths 132A, 132B, and 132C may lead to a single air opening 134. In another example, each of the airflow paths 132A, 132B, and 132C may lead to an independent air opening 134 designated for that airflow path. The air opening 134 leads to an airflow chamber 168 of the container body 150. As there is a single air opening 134, all of the airflow paths 132A, 132B, and 132C lead to the same airflow chamber 168 of the container body 150.

In an example, the cleaned air outlet 182 may be independent of the generally spirally arranged wall system. In another example, the generally spirally arranged wall system define the cleaned air outlet In an example, the outlet 182 may be in the form of a tube 180 having a height exceeding the height of the generally spirally arranged wall system 122, and extend through the cover. The cleaned air outlet 182 may be generally cylindrical and arranged at a central longitudinal axis of the intake 110B and/or the container body. The tube 180 may be configured to coupling to an engine (as shown in FIG. 1) and may include a connection flange, for example.

The cleaned air outlet 182 may be defined by the tube 180, which may be supported off of the cover of the intake and suspended to extend through the intake to the air flow chamber of the container body 150. The cleaned air outlet 182 may be centered around the central longitudinal axis of the intake 110B. The cleaned air outlet 182 may not be in direct communication with the dust flow path or airflow path in the generally spirally arranged wall system. Instead, as with the intake 110A, the air may flow from the generally spirally arranged wall system into the container body 150 and subsequently may flow through the cleaned air outlet 182. The cleaned air outlet 182 may be configured to be in fluid communication with an engine or other machine attached to the air filtration system.

The container body 150 for use with the intake 110B may be the same or similar to the container body 150 for use with the intake 110A and is not further described. In another example, the container body 150 for use with the intake 110B may be substantially similar to the container body 150 but may include a divider extending longitudinally and radially between the interior chamber portion and the exterior chamber portion. The divider may be configured to separate the dust flow chamber 162 of the container body 150 into separate dust flow chambers. For example, the divider may establish multiple dust flow chambers that correspond to respective dust openings 130A/B/C, which may help to reduce the potential for dust to enter one opening and exit another. The divider may extend between the interior chamber portion and the exterior chamber portion and from the first end of the container body 150 to the second end of the container body 150. In another example, the divider may extend radially between the interior chamber portion and the exterior chamber portion and from the first end of the container body 150 only a portion of the way to the second end of the container body 150. In some examples, the divider may extend longitudinally through all or a portion of the cylindrical portion, through all of the cylindrical portion and a portion of the conical portion, or another length or even intermittent sections may be provided.

The intake 110B, or the container body the intake 110B is coupled to, may include an attachment mechanism 138. The attachment mechanism 138 may extend laterally from the intake 110B or the container body. The attachment mechanism 138 may couple the air filtration system 100 to a work machine, such as an engine, or a component adjacent to the engine. The attachment mechanism 138 may include apertures configured to receive fasteners.

### INDUSTRIAL APPLICABILITY

In operation and in use, the air cleaner may provide for efficient cleaning of air. That is, the air cleaner, which may be part of a larger air filtration system cleans the air by removing dirt and dust before the air enters the engine of the work machine. That is, the air cleaner may include a spirally arranged wall system that efficiently receives and directs dust through a dust opening to a dust collection chamber and away from an airflow path. This may occur through an abrupt change in direction or abrupt offsetting of the air flow path where the dust, dirt, and debris in the air continue straight toward a dust flow path. The air cleaner may also induce cyclonic motion of the air and redirection of the air to remove further dust, dirt, and debris from the air. By increasing efficiency and decreasing back flow, costs may be reduced as replacement of parts or cleaning of parts may be performed less frequently and may have an overall longer life span.

A method of dust removal may include directing air from outside a container body through an inlet of an intake arranged at a first end of the container body. The container body may include the first and a second end and may define a dust flow chamber and an airflow chamber. The air from the outside may be directed through a generally spirally arranged wall system of the intake. In moving through the generally spirally arranged wall system the air from the outside diverges into a dust flow path and an airflow path. More particularly, the dust flow path may be in general alignment with the incoming pathway from the inlet and the air flow path may abruptly change direction and continue along, but offset from, the incoming pathway from the inlet. In this manner, the air may not be able to carry the dust, dirt, and/or debris laterally through the abrupt side stepping of the air flow path and the dust, dirt, and/or debris may continue generally straight to and along the dust flow path while the air moves laterally and along the airflow path. The dust flow path may be in fluid communication with the inlet via an initial incoming air/dust flow path and may extend to a dust opening. The dust opening may lead to the dust flow chamber. The airflow path may diverge laterally from the incoming air/dust flow path at a branch and extend to an air opening The air opening may lead to an airflow chamber. The air flow path may be a generally spiral path leading to the air opening such that the air passing through the air opening is moving in a spiraling motion and induces cyclonic motion with the air flow chamber. The method may include directing air from outside the container body through a plurality of inlets into the intake. While the dust flow path has been described as being in communication with the inlet via an initial incoming air/dust flow path, the dust flow path may be considered to extend from the inlet to the dust opening with an air flow path diverging from the dust flow path.

The method may include collecting dust particles in a first dust collection chamber positioned at the second end of the dust flow chamber. A portion of the first dust collection chamber may be removably coupled to the first dust collection chamber or the dust collection chamber and the method may include removing dust from the dust collection chamber.

The method may include directing the air through the container body for further cleaning. For example, the method may include directing air through the air opening into the air flow chamber of the container body. Dust may be removed from the air in the air flow chamber by directing air around a cylindrical chamber arranged at the first end of the container body. That is, the spiral shape of the intake may cause the air to enter the air flow chamber in spiraling fashion and it may move in cyclonic motion as it passes down into the air flow chamber. The cleaned air may be redirected to a cleaned air outlet arranged at the first end of the container body along a central longitudinal axis of the container body via a conical chamber fluidly coupled to the cylindrical chamber. The method may include collecting dust particles in a second dust collection chamber at the second end of the container body. The dust particles may be directed into the second dust collection chamber via the conical chamber. A portion of the second dust collection chamber may be removably coupled to the container body, second dust collection chamber, or the conical chamber. The method may also include removing dust from the second dust collection chamber.

The air may then flow into an engine. As the air has passed through the intake and body container, the air may be substantially clean prior to entering the engine. Accordingly, the engine may have a longer life span and operate at a higher efficiency with lower costs. The pre-cleaner may clean the air sufficiently such that back flow is substantially reduced, therefore costs are reduced as replacement of parts or cleaning of parts is required less frequently and thus have a longer life span. When used in conjunction with an air filter, the life of the filter media may be prolonged and changing of the filter media may be performed less frequently.

The above detailed description is intended to be illustrative, and not restrictive. The scope of the disclosure should, therefore, be determined with references to the appended claims, along with the full scope of equivalents to which such claims are entitled.

What is claimed is:

1. An air cleaner, comprising:
a container body having a first end and a second end and defining an air flow chamber and a dust flow chamber each defining separate internal cavities within the container body; and
an intake arranged at the first end of the container body and comprising a wall system for receiving air from outside the container body through an inlet in the side of the container body, the intake comprising:
a dust flow path in fluid communication with and in general alignment with the inlet and extending from the inlet to a dust opening leading to the dust flow chamber; and
an airflow path abruptly and angularly diverging from the dust flow path at a point downstream of the inlet and extending from the dust flow path to an air opening leading to the air flow chamber.

2. The air cleaner of claim 1, wherein the wall system defines the inlet.

3. The air cleaner of claim 2, wherein the wall system defines a plurality of inlets, plurality of dust flow paths, and a plurality of airflow paths.

4. The air cleaner of claim 1, wherein the dust flow chamber comprises a first dust collection chamber proximal the second end of the container body.

5. The air cleaner of claim 4, wherein a portion of the first dust collection chamber is removably coupled to the first dust collection chamber.

6. The air cleaner of claim 1, wherein the air flow chamber comprises:
a cylindrical chamber arranged at the first end of the container body, wherein the air opening is arranged at a first end of the cylindrical chamber;
a conical chamber fluidly coupled to the cylindrical chamber; and
a cleaned air outlet arranged at the first end of the container body along a central longitudinal axis of the container body.

7. The air cleaner of claim 6, wherein the air flow chamber comprises a second dirt collection chamber fluidly coupled to the conical chamber, and arranged at the second end of the container body.

8. The air cleaner of claim 7, wherein a portion of the second dirt collection chamber is removably coupled to the conical chamber.

9. The air cleaner of claim 6, wherein the air flow chamber is configured to separate air and dust, and redirect cleaned air to the cleaned air outlet.

10. The air cleaner of claim 6, wherein the air flow chamber extends through the dust flow chamber along the central longitudinal axis of the dust flow chamber.

11. The air cleaner of claim 3, further comprising a divider within the dust flow chamber.

12. A work machine comprising:
a frame;
an engine mounted on the frame, configured to perform work, and including a combustion air intake; and
an air cleaner comprising:
a container body having a first end and a second end and defining an air flow chamber and a dust flow chamber each defining separate internal cavities within the container body; and
an intake arranged at the first end of the container body and comprising a wall system for receiving air from outside the container body through an inlet in the side of the container body, the intake comprising:
a dust flow path in fluid communication with and in general alignment with the inlet and extending from the inlet to a dust opening leading to the dust flow chamber; and
an airflow path abruptly and angularly diverging from the dust flow path at a point downstream of the inlet and extending from the dust flow path to an air opening leading to the air flow chamber;

13. A method of dust removal, comprising:
directing air from outside a container body having a first end and a second end, through an inlet into an intake arranged at a first end of the container body;
directing the air from the outside through a wall system of the intake;
diverging a dust flow path and an airflow path of the air from the outside,
wherein the dust flow path is in fluid communication with and in general alignment with the inlet and extending from the inlet to a dust opening leading to a dust flow chamber defined by the container body, and
wherein the airflow path is at a point downstream of the inlet and extends from the dust flow path to an air opening leading to an air flow chamber defined by the container body.

14. The method of claim 13, further comprising:
collecting dust particles in a first dust collection chamber at a second end of the dust flow chamber, wherein a portion of the first dust collection chamber is removably coupled to the first dust collection chamber or the dust collection chamber.

15. The method of claim 13, further comprising:
directing air through the air opening into the air flow chamber;
removing dust from the air in the air flow chamber by directing air around a cylindrical chamber arranged at the first end of the container body;
directing cleaned air to a cleaned air outlet arranged at the first end of the container body along a central longitudinal axis of the container body.

16. The method of claim 15, wherein the cleaned air is directed to the cleaned air outlet via a conical chamber fluidly coupled to the cylindrical chamber.

17. The method of claim 16, further comprising:
collecting dust particles in a second dust collection chamber at the second end of the container body, wherein the second dust collection chamber is removably coupled to the container body or the conical chamber.

18. The method of claim 13, wherein directing air from outside the container body comprising directing the air from outside through a plurality of inlets into the intake.
